(19) United States
(12) Patent Application Publication
(10) Pub. No.: US 2010/0013958 A1
(43) Pub. Date: Jan. 21, 2010

(54) IMAGING SYSTEM WITH BUILT-IN IMAGE SEARCH FUNCTION

(75) Inventor: QING-FA OU, Foshan (CN)

Correspondence Address: PCE INDUSTRY, INC.;ATT. Steven Reiss, 288 SOUTH MAYO AVENUE, CITY OF INDUSTRY, CA, 91789, US

(73) Assignees: PREMIER IMAGE TECHNOLOGY(CHINA) LTD., Foshan City (CN); HON HAI PRECISION INDUSTRY CO., LTD., Tu-Cheng (TW)

(21) Appl. No.: 12/340,746

(22) Filed: Dec. 22, 2008

(30) Foreign Application Priority Data
Jul. 17, 2008 (CN) 200810302782.9

(51) Int. Cl. H04N 5/76; G06F 17/30

(52) U.S. Cl. 348/231.2; 707/3; 707/E17.014; 348/E05.024

(57) ABSTRACT

An imaging system, the imaging system may be a DSC, and a mobile phone, and includes a imaging module, a storage module, display module, a metadata module, and an image search module. The imaging module is for acquiring images. The storage module is for storing the acquired images of the imaging module. The display module is for displaying the images and interactive windows for a user. The metadata module is configured for writing new metadata to image(s) in response to an input of the user. The image search module is configured for searching desired image(s) by comparing a search term input by a user and added metadata of the image(s).

### TECHNICAL FIELD

The present disclosure relates to an imaging system capable of quickly accessing desired image(s) stored therein.

### BACKGROUND

Being limited by their display sizes, electronic apparatuses equipped with image capturing functions, such as digital still cameras or mobile phones, usually can only display one photo at a time or a group of thumbnails of different photos. However, electronic apparatuses now typically provide gigabytes of storage capacity. So even if several images can be viewed at a time it can still be very time consuming to manually search through images to locate specific ones.

What is needed, therefore, is an imaging system to overcome the above-mentioned problems.

### BRIEF DESCRIPTION OF THE DRAWINGS

FIG. 1 is a functional block diagram of an imaging system, according to a first exemplary embodiment.

FIG. 2 is a functional block diagram of an imaging system according to a second exemplary embodiment.

### DETAILED DESCRIPTION OF THE EMBODIMENTS

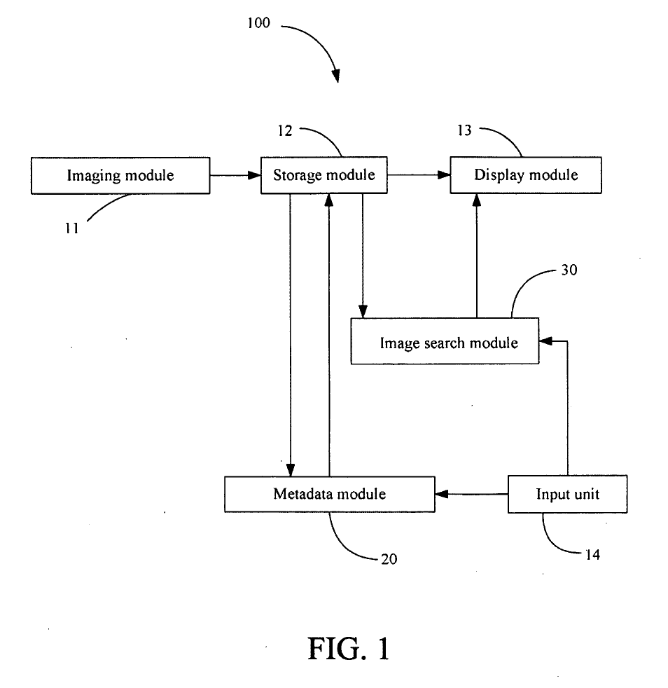

Referring to FIG. 1, an imaging system 100, according to a first exemplary embodiment, is shown. The imaging system 100 may be a digital still camera (DSC), or a mobile phone, and includes an imaging module 11, a storage module 12, a display module 13, a metadata module 20, and an image search module 30. The imaging module 11 is for acquiring images. The storage module 12 is for storing the acquired images of the imaging module 11. The display module 13 is for displaying the images and user interfaces, e.g., an image editing window or an image search window, for a user. The metadata module 20 is configured for adding metadata to image(s) in response to an input of the user. The image search module 30 is configured for searching for a desired image(s) by comparing a query input by a user with the metadata of the image(s).

The imaging module 11 typically includes a lens and an image sensor. The lens is for focusing an optical image onto the image sensor. The image sensor is for converting the optical image into electrical signals, which will be processed as an image file and stored in the storage module 12.

The storage module 12 can be a flash memory card.

Commonly, each of the images use exchangeable image file format (EXIF). An EXIF file is capable of recording metadata tags of the images. The added metadata is written in EXIF files, which can be handled by the image search module 30. For example, the added metadata can be a signature of a user, a category assigned by a user, or remarks by a user.

The imaging system 100 further includes an input unit 14 to allow users to edit the images, to add metadata to the images, and to search for images.

For example, after an image of sunset has been captured by the imaging module 11, an image editing window (not shown) may be generated and displayed on the display module 13 to prompt the user to categorize the image, at which time the user may input “landscape” or “sunset” for the category, sign the image, and/or make remarks such as “good quality” and “artistic”. Then the image is stored in association with the category, signature, and/or remarks in the storage module 12 as its metadata.

Also, metadata can be added after the image has been stored in the storage module 12. For example, when the user cleans up the storage module 12, he may view the images one by one or search for specific image(s) and view them on the display, and add new metadata to the displayed image(s).

The input unit 14 can be a keypad provided on the outer surface of the imaging system 100. Alternatively, the input unit 14 can be integrated into the display module 13, constituting a touch-screen display.

The image search module 30 can be activated when it is desired to view one or more specific images.

For example, when the user wishes to review the image of the sunset, he can open an image search window (not shown) via the input unit 14 and input a search term, e.g., a category, a signature, a remark or any combination thereof also via the input unit 14, in this case the user may enter “sunset”. The image search module 30 receives the search term, finds any matches in the storage module 12, and then accesses the matches if any, and displays the result. Images displayed may be edited.

Various components of the imaging system 100 such as the matadata adding module 20 and the image search module 30 can be individual electrical elements or intergrated into a central unit. Alternatively, the components can be software modules written by a variety of programming languages such as such as C, C++, Java, Visual Basic and many others.

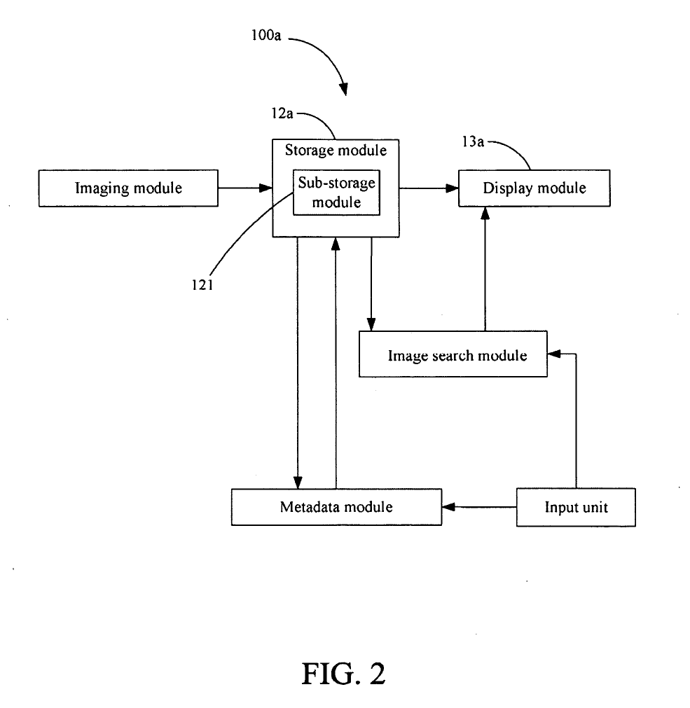

Referring to FIG. 2, an imaging system 100a, according to a second exemplary embodiment, is similar to the imaging system 100 of the first exemplary embodiment, except with respect to the storage module 12a. In this embodiment, the storage module 12a includes a sub-storage module 121. The sub-storage module 121 stores a file therein. The file is for recording filenames of the images stored in the storage module 12a. Each filename is linked to a corresponding image stored in the storage module 12a. The image search module 30a can then have filenames corresponding to images associated with metadata matching a search term listed on the display module 13a. Then the user can access the desired image(s) by operation of the list. For example, the user can double click an option of the list, which is associated with a desired image, and accordingly the image is accessed and displayed on the display module 13a.

The imaging system with the metadata module and the image search module can quickly find out the target image(s) by adding additional metadata in the target image(s), and improve the image searching efficiency.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An imaging system comprising:
a imaging module for acquiring images;
a storage module for storing the images acquired by the imaging module;
a display module for displaying the images and interactive user interfaces;
a metadata module configured for adding new metadata into image(s); and,
an image search module configured for searching for a desired image(s) by comparing a search term input by a user with metadata of the image(s).

2. The imaging system as claimed in claim 1, wherein the imaging system further comprises an input unit to allow users to edit the images and to search for images.

3. The imaging system as claimed in claim 2, wherein the input unit is configured as a keypad.

4. The imaging system as claimed in claim 1, wherein each of the images uses an EXIF file for recording metadata tags of the image.

5. The imaging system as claimed in claim 4, wherein the added metadata is written in EXIF files, which can be handled by the image search module.

6. The imaging system as claimed in claim 4, wherein the added metadata is a signature of a user, a category defined by a user, or remarks by a user.

7. The imaging system as claimed in claim 1, wherein the matadata adding module and the image search module are software modules written by programming languages.

8. The imaging system as claimed in claim 7, wherein the programming language is C, C++, Java, or Visual Basic.

9. The imaging system as claimed in claim 1, wherein the storage module is a flash memory card.

10. The imaging system as claimed in claim 1, wherein the storage module comprises a sub-storage module configured for storing a file therein for recording filenames of the images stored in the storage module.

11. The imaging system as claimed in claim 10, wherein each filename is linked to a corresponding image stored in the storage module.

12. The imaging system as claimed in claim 1, wherein the imaging module comprises a lens and an image sensor, the lens is for focusing an optical image onto the image sensor, the image sensor is for converting the optical image into electrical signals, which will be processed as an image and stored in the storage module.
